(19) United States
(12) Patent Application Publication
(10) Pub. No.: US 2010/0205354 A1
(43) Pub. Date: Aug. 12, 2010

(54) STORAGE DEVICE USING FLASH MEMORY

(76) Inventor: Masumi Suzuki, Aichi (JP)

Correspondence Address: Kubotera & Associates, LLC, 200 Daingerfield Rd, Suite 202, Alexandria, VA, 22314, US

(21) Appl. No.: 12/678,657

(22) PCT Filed: May 7, 2008
(86) PCT No.: PCT/JP2008/058888

§ 371 Date: Mar. 17, 2010

(30) Foreign Application Priority Data
Mar. 26, 2008 (JP) 2008-079774

(51) Int. Cl. G06F 12/02; G06F 12/00

(52) U.S. Cl. 711/103; 711/E12.001; 711/E12.008

(57) ABSTRACT

Provided is a system whose effective endurable number of rewrite times can be drastically improved in a storage device using a flash memory whose rewrite life is restricted. The logical address (LBA) of a sector in which data which is not used as a file system is accumulated is detected. Mapping information on a physical address (PBA) corresponding to the logical address is released. A block in which the mapping information on every logical address and physical address is released out of blocks of the flash memory is deleted and used as an alternative block for wear leveling.

### TECHNICAL FIELD

The present invention relates to a storage device including a flash memory formed of a nonvolatile semiconductor as a storage medium. Further, the present invention relates to an information device equipped with the storage device.

### BACKGROUND ART

A hard disc drive (an HDD) is the most common storage device of an information device. When a file is stored in the HDD, the file is divided into storage units called sectors and the sectors are stored at corresponding physical locations of the storage media. Accordingly, upon rewriting, the file is basically rewritten at the same locations.

In the HDD, when a host computer assigns the sector at a location away from a head which reads magnetic information, it is necessary to move the head to the corresponding storage area (seek), thereby deteriorating read/write performance. Further, it is necessary to provide mechanical features for moving the head and rotating a disc, thereby resulting in lesser reliability.

Contrastingly, a storage device using a semiconductor memory attracts much attention these days. More specifically, there has been an attention to a storage device using a NAND type flash memory, one of flash memories which are nonvolatile memories capable of rewriting electrically. The storage device uses the semiconductor memory as a storage medium without the mechanical feature, thereby improving reliability thereof. In addition, it is not necessary to move the head as the HDD, it is possible to prevent the read/write performance from lowering.

The NAND type flash memory is erased per a unit called a block. The block has a limited number of cycles for erasing and writing. Normally, the number of guaranteed cycles is 10,000-100,000 times for each block. Therefore, when the storage device is configured using the NAND type flash memory, a controlling technique (generally called a wear leveling control or a leveling process) is used so that a particular physical block is not written intensively.

As one of methods for the wear leveling, a user area and a spare block area are provided in the NAND type flash memory. The user area is an area for saving data therein through a command from a host computer. The spare block area is an area secured as an erased block for the wear leveling. When the host computer controls to rewrite data, only the block having a physical address to be rewritten is replaced with the block in the spare block area while the block with the physical address not to be rewritten remains as is, thereby performing the wear leveling control.

Patent References 1, 2, 3 and 4 have disclosed the method described above as the controlling technique of the wear leveling.
Patent Reference 1: Japanese Patent Publication No. 2005-209184
Patent Reference 2: Japanese Patent Publication No. 2007-280329
Patent Reference 3: Japanese Patent Publication No. 2007-293726
Patent Reference 4: Japanese Patent Publication No. 2007-323159

FIGS. 1 to 3 are views showing an overview of a conventional device using the wear leveling control described above.

FIG. 1 is a block diagram showing a configuration of the conventional device. A storage device 10 includes a host computer communication unit 2; a command analysis unit 3; a buffer memory 4; a logical-physical address conversion unit 5; a wear leveling control unit 6; an ECC control unit 7; a flash read/write control unit 8 and an NAND flash memory 9.

The host computer communication unit 2 communicates with a host computer 1. Generally, the host computer communication unit 2 is designed to have a specification called IDEif. The command analysis unit 3 analyzes a command sent from the host computer 1, and controls an execution of the command.

The buffer memory 4 temporarily holds data received from the host computer 1 or data to be sent to the host computer 1. The logical-physical address conversion unit 5 includes an MAP table. The MAP table represents a relationship between a logical address assigned together with the command from the host computer 1 and a physical address of the NAND flash memory 9.

The wear leveling control unit 6 determines the physical address to be assigned when the host computer 1 sends a writing command. The ECC control unit 7 performs an error correction control. More specifically, when the data is read from or the data is written to the NAND flash memory 9, the ECC control unit 7 calculates ECC data. When a bit error occurs, the ECC control unit 7 corrects the error if the error can be corrected.

FIG. 2 is a schematic view showing a storage area of the NAND flash memory 9. A user data area is composed of a group of blocks for storing the data sent from the host computer 1. A bad block area is composed of a group of bad blocks of the NAND flash memory 9 inherently generated or generated upon an operation thereof.

A controller management area stores various information used by a controller for controlling the NAND flash memory 9 for a management purpose. A wear leveling spare block area is a group of blocks substituted with existing blocks in the user data area when the host computer 1 sends the command to write the data. The group of the blocks are then used for newly saving the data commanded by the host computer 1.

When the data in the storage device 10 is read from the host computer 1, the host communication unit 2 receives the command. Then, the command analysis unit 3 analyzes that the command is a read command, and converts into a physical address corresponding to a logical address sector according to the logical-physical address conversion table.

Next, the command analysis unit 3 readouts the data from the NAND flash memory 9 to the buffer memory 4 through the flash read/write control unit 8. Further, the ECC control unit 7 checks whether the bit error occurs or not.

When the bit error does not occur or as far as the bit error is capable of being corrected, the ECC control unit 7 corrects the bit error, and then the data is sent to the host computer 1 through the host communication unit 2, thereby completing the command.

When the data is written from the host computer 1 to the storage device 10, the host communication unit 2 receives the command and the command analysis unit 3 analyzes that the command is a write command. Further, the command analysis unit 3 temporarily writes the data to be written and received from the host computer 1 into the buffer memory 4. Afterward, referring to the logical-physical address conversion table, the physical address corresponding to the logical address sector being assigned is calculated.

Among the groups of the blocks in the wear leveling spare block area, the wear leveling control unit 6 selects an address of the physical block which is newly corresponding to the logical address described above, as a substitution for the existing physical address described above.

Next, the command analysis unit 3 copies a portion of the data with the existing physical address which is not to be rewritten, to a new block through the flash read/write control unit 8. Further, the command analysis unit 3 performs data copy, so that a portion of the data to be rewritten is copied from the buffer memory 4. At this moment, the ECC control unit 7 performs a specific ECC calculation, so that a result of the ECC calculation is saved. Lastly, the physical blocks in which the existing data is saved are erased, and reused as a group of the blocks in the spare block area for the wear leveling.

FIG. 3 is a schematic view showing states of the physical blocks of the NAND flash memory 9 before and after being written. A state shown on a left side in FIG. 3 represents the state before being rewritten. When a sector 0 is rewritten, a physical block 1 is newly selected. Data in the sector 0 and data in a sector 1 to a sector 255 are written in the physical block 1. The data from the sector 1 to the sector 255 are not to be rewritten. Later, the physical block 0 is erased.

### DISCLOSURE OF THE INVENTION

### Problem to be Solved by the Invention

In the controlling technology described above, the number of the physical blocks of a spare block area for the wear leveling is about 4% of the total physical blocks. That is a sum of the number of the physical blocks capable of being substituted with the bad blocks in the flash memory or the possible maximum number of the bad blocks in an initial state (2%), and the maximum number of the possible bad blocks to be generated (2%) in order to certify a rewriting life. Therefore, when a particular logical address is rewritten intensively from the host computer, the wear leveling is performed only within the physical blocks in the spare block area occupying about 4%, thereby shortening a life of the device.

An object of the present invention is to provide a storage device capable of improving an effective lifetime thereof with respect to rewriting times of a system even when a particular physical block is rewritten intensively. In the storage device, physical blocks in a user area unused in view of file system management are utilized as blocks in a spare block area for the wear leveling, thereby effectively increasing the blocks in the spare block area.

### Aspects for Solving the Problems

In a storage device of the present invention, a host system manages data stored in the storage device using a file system. In the storage device, a physical block of a flash memory, where unused data for reasons of file system management are stored, is erased, so that a corresponding relationship between a logical address and a physical address is canceled. Accordingly, the physical block is used for wear leveling.

More specifically, according to an aspect of the present invention, the storage device uses the flash memory, which has a limited number of cycles, for erasing and writing per block. The storage device includes a user area for storing data assigned from the host system in the flash memory. Further, the storage device includes a spare block area. The spare block area is a group of blocks erased already and used for leveling a number of rewriting times of each of the blocks.

The storage device further includes an address conversion table for managing the corresponding relationship in the user area, between the logical address provided from the host system and the physical address in the flash memory.

The storage device further includes a wear leveling control unit for directing an address management unit to exchange the physical block corresponding to the data with the physical block in the spare block area when the host system commands to rewrite the data in the user area.

Furthermore, the storage device includes an unused sector detection unit for detecting a sector area in the user area where unused data are stored according to the file system. The unused sector detection unit notifies information thus provided to the address management unit, and directs the address management unit to cancel the corresponding relationship between the logical sector address and the physical sector address.

The storage device further includes an unused sector registration unit for canceling the corresponding relationship between the logical sector address and the physical sector address according to the information thus notified from the unused sector detection unit.

The storage device further includes an unused block substitution unit. The unused block substitution unit erases a physical block with the canceled corresponding relationship between the logical sector address and the physical sector address among the physical blocks as an erasing unit of the flash memory. The unused block substitution unit further converts the physical block to a usable block in the spare block area.

According to another aspect of the present invention, an information device is formed of a storage device using a flash memory and a host system of the storage device.

The information device manages data stored in the storage device using a file system. The host system includes an unused sector detection notification unit. The unused sector detection notification unit notifies the storage device of a logical sector where unused data is stored for reasons of file system management.

The storage device includes an unused sector registration unit for canceling a corresponding relationship between a logical sector address and a physical sector address according to the information notified from the host system including the unused sector detection notification unit.

The storage device further includes a block substitution unit. The block substitution unit erases a physical block with the canceled corresponding relationship between the logical sector address and the physical sector address among the physical blocks as an erasing unit of the flash memory. The unused block substitution unit further converts the physical block to a usable block in the spare block area.

### Effects of the Invention

According to the present invention described above, the physical block unused by the file system is converted to the spare block area for the wear leveling. As a result, though the spare block area for the wear leveling occupies about 4% of all areas at an initial time similar to a conventional device, the spare block area for the wear leveling can be greater than the initial level of 4%, thereby performing the wear leveling more effectively. Accordingly, it is possible to prolong a life of the device.

In addition, another effect is described as follows. In the conventional device, when a file is removed on the file system, only chain information of the above-mentioned clusters is erased while a substantial data portion is not erased. Accordingly, it is possible to recover the file which has been erased through running a specialized program. As a result, problems can be caused by a leak of information of recovered data from discarded personal computers. In order to entirely erase the substantial data portion, it is necessary to separately run a specific for special purpose.

According to the present invention, the physical block where the substantial data of the file are stored becomes the unused block and thus erased even if the file is erased in the file system, that is, only the chain information of the clusters is erased. Accordingly, the substantial data of the file can be erased without running a specific program for the special purpose.

### BRIEF DESCRIPTION OF THE DRAWINGS

FIG. 1 is a block diagram showing a configuration of a conventional device;

FIG. 2 is a schematic view showing a state of storage to a NAND flash memory;

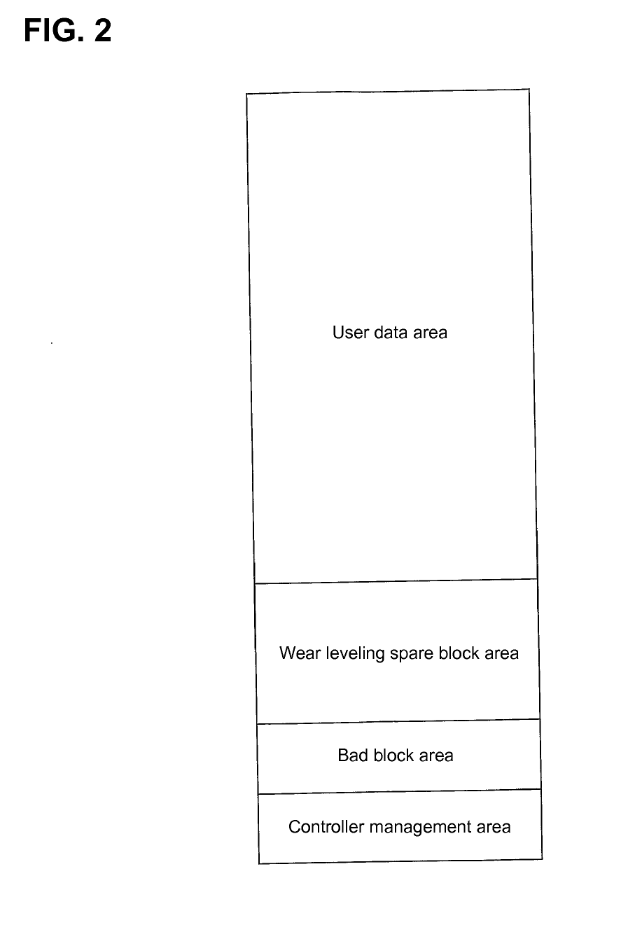

FIG. 3 is a pair of schematic views showing states of storage to the NAND flash memory;

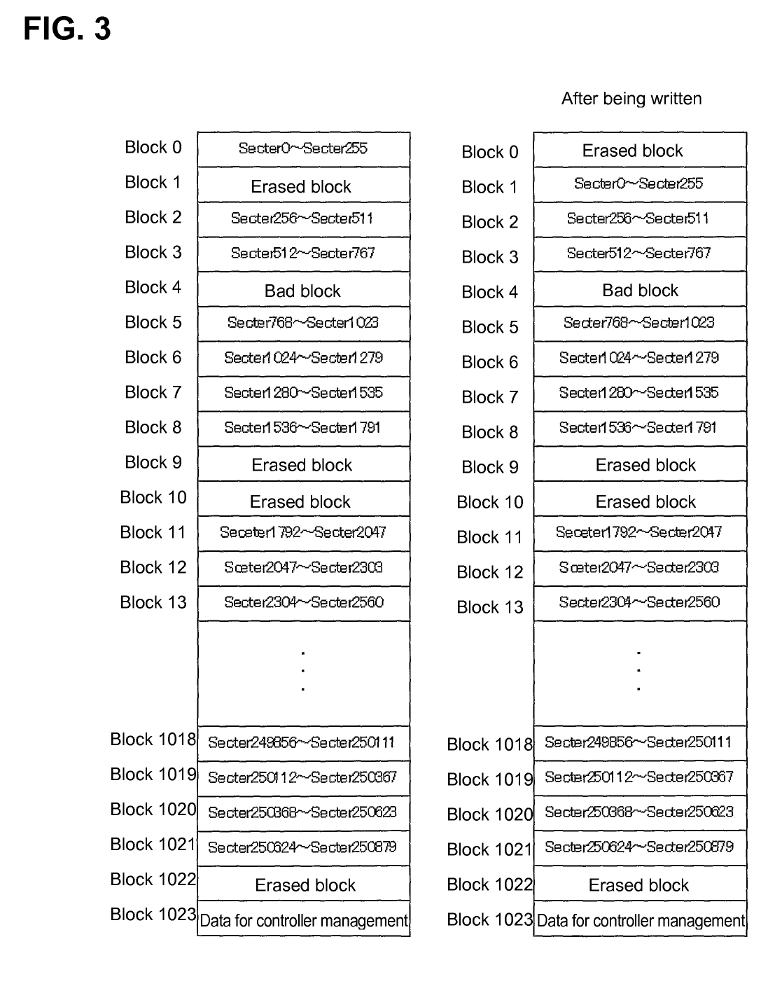

FIG. 4 is a block diagram showing a first embodiment of the present invention;

FIG. 5 is a schematic view describing a FAT file system;

FIG. 6 is a schematic view showing MBP of the FAT file system;

FIG. 7 is a schematic view showing BPB of the FAT file system;

FIG. 8 is a schematic view showing a FAT table of the FAT file system;

FIG. 9 is a schematic view showing directory information of the FAT file system;

FIG. 10 is a pair of schematic views showing states of storage to the NAND flash memory at the physical blocks according to the first embodiment of the present invention;

FIG. 11 is a block diagram showing a second embodiment of the present invention;

FIG. 12 is a block diagram showing a third embodiment of the present invention; and

FIG. 13 is a block diagram showing a fourth embodiment of the present invention.

### DESCRIPTION OF THE REFERENCE SYMBOLS

1 HOST COMPUTER

2 HOST COMPUTER COMMUNICATION CONTROL UNIT

3 COMMAND ANALYSIS UNIT

4 BUFFER MEMORY

5 LOGICAL-PHYSICAL ADDRESS CONVERSION TABLE

6 WEAR LEVELING CONTROL UNIT

7 ECC CONTROL UNIT

8 FLASH READ/WRITE CONTROL UNIT

9 NAND FLASH MEMORY

10 STORAGE DEVICE

101 UNUSED SECTOR DETECTION UNIT

102 UNUSED SECTOR REGISTRATION UNIT

103 UNUSED BLOCK SUBSTITUTION UNIT

104 UNUSED SECTOR DATA NOTIFICATION UNIT

105 UNUSED SECTOR DETECTION UNIT

### BEST MODES FOR CARRYING OUT THE INVENTION

Hereunder, embodiments of the present invention will be explained with reference to the accompanying drawings.

### First Embodiment

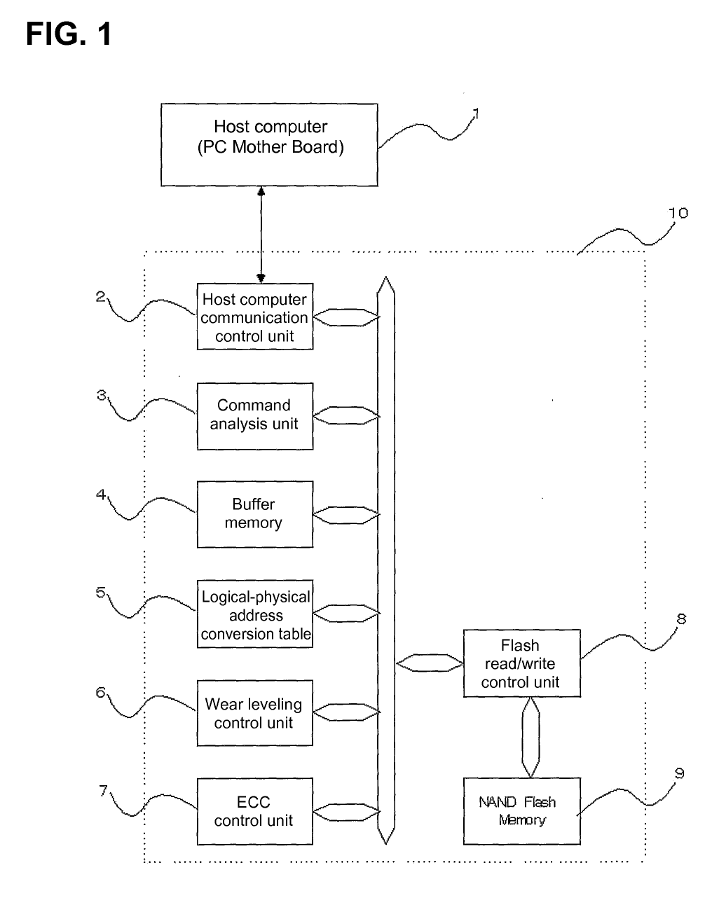

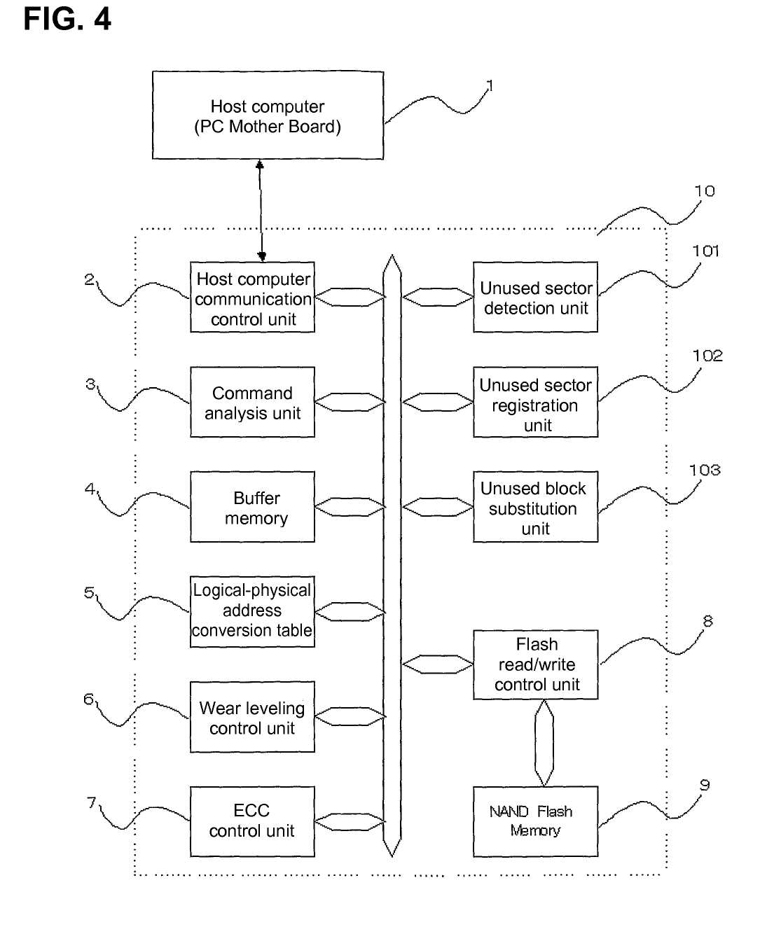

FIG. 4 is a block diagram showing a configuration of a storage device according to a first embodiment of the present invention. A host computer 1 and a storage device 10 are similar to a conventional device shown in FIG. 1, except an unused sector detection unit 101, an unused sector registration unit 102 and an unused block substitution unit 103. In addition, a performance when the host computer 1 sends a read/write command is performed in a similar way to the conventional example as well.

The unused sector detection unit 101 is for detecting a virtually unused sector in a user data area of a NAND flash memory 9. The unused sector registration unit 102 is for holding information of the unused sector detected by the unused sector detection unit 101. The unused block substitution unit 103 erases a physical block and substitutes the physical block for a substitution block usable for wear leveling if it is determined from the information held in the unused sector registration unit 102, that an entire area of the physical block of the NAND flash memory 9 is applicable.

Next, a management by an operating system (an OS) of the host computer 1 will be explained. A process of detection the unused sector by the unused sector detecting unit 101 will be explained as well.

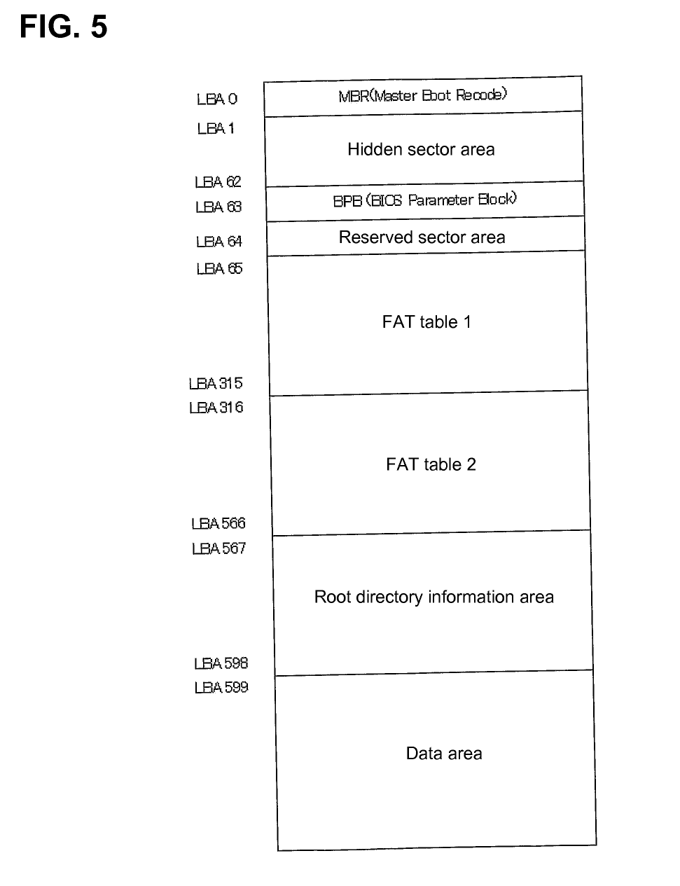

FIG. 5 is a schematic view showing a relation between logical address and content thereof when using a FAT format for formatting. The FAT format is commonly used for managing storage devices. In the embodiment, an LBA is a logical address and the LBA starts from LBA 0.

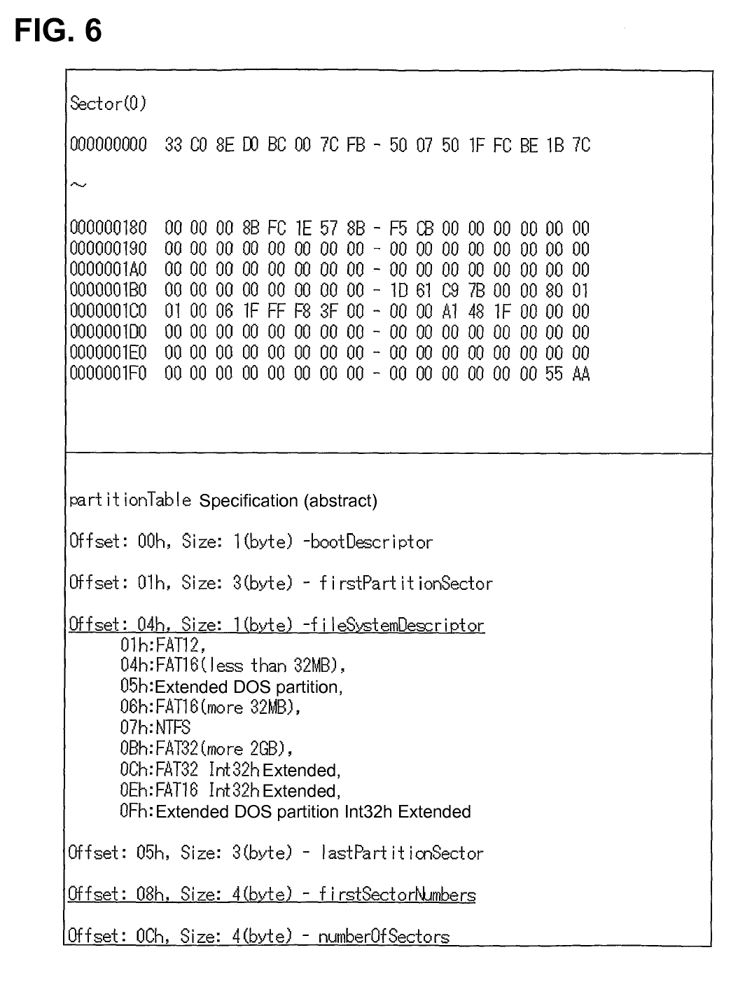

FIG. 6 is a schematic view showing a detail of an MBR, which is at LBA 0. Starting from an address 1BDh, information about each of partitions is written every 16th byte. In the every 16th byte, information about format system is stored at offset 04h. Further, address information of a BPB is stored at offset 08h. The BPB shows a starting location of each of the partitions.

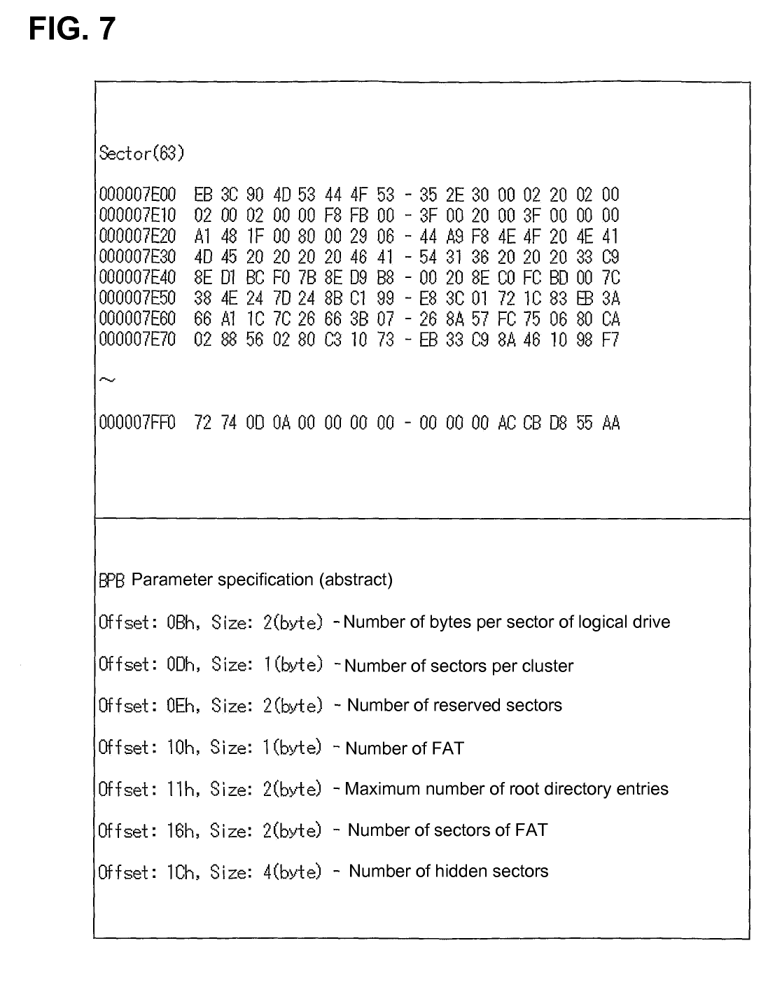

FIG. 7 is a schematic view showing a detail about the BPB. The BPB is a starting sector of the partition. Information about size of a cluster is placed at 0 DHth byte. The cluster is a unit managed by the OS. In addition, a size of a FAT table, a number of the FAT table and information about size of a root directory are stored.

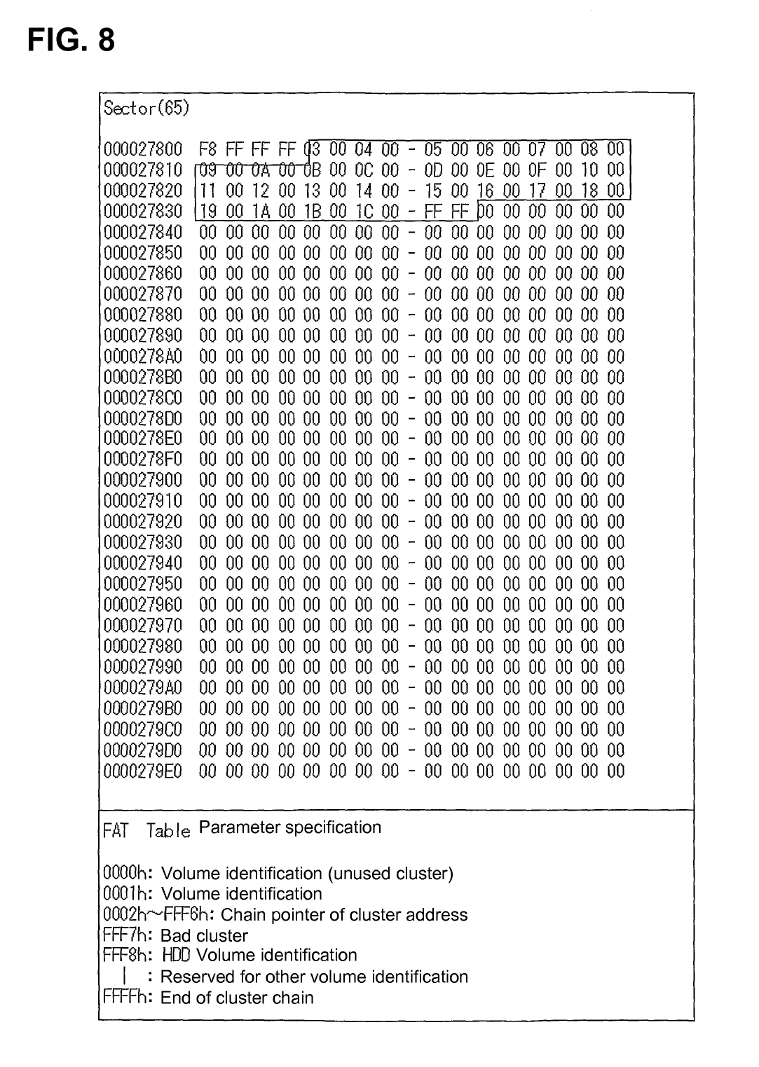

FIG. 8 is a schematic view showing a detail about a first sector of the FAT table. As it is known, the FAT table is composed of chain information of the clusters only.

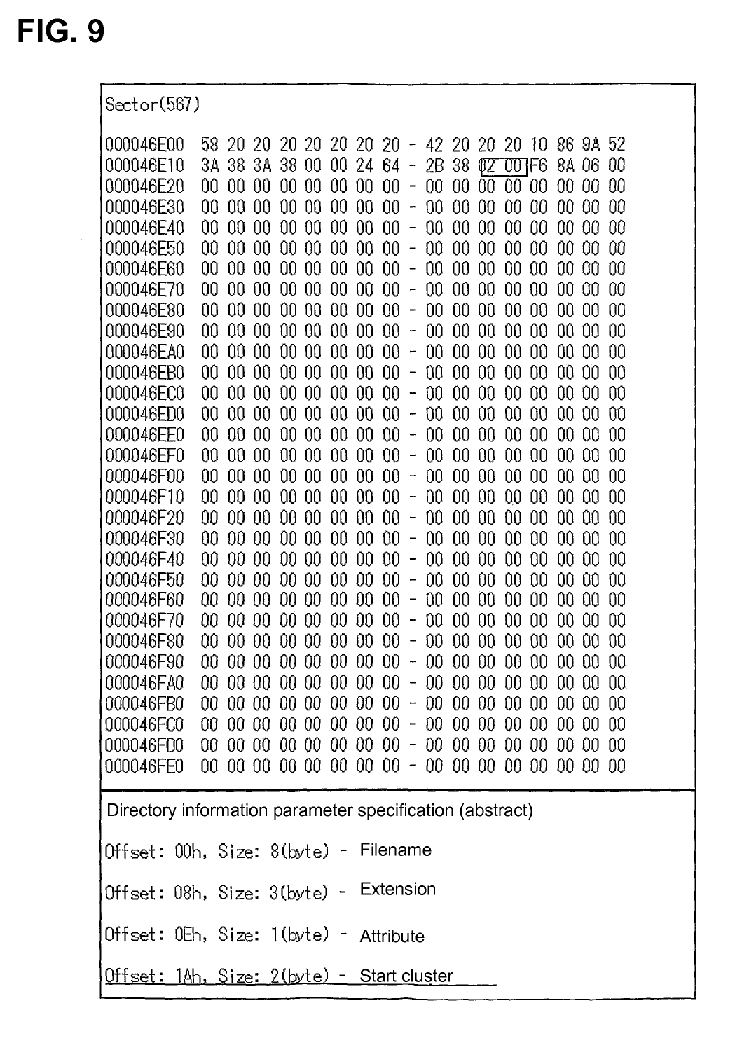

FIG. 9 is a schematic view showing a detail about directory information. The directory information is composed of 32 bytes and at offset 1 Ah, information about a starting cluster is stored. The starting cluster stores substantial data therein. As described above, an unused cluster, that is, an unused logical address sector (LBA) can be located by analyzing the information described above. Therefore, the unused sector detecting unit 101 can detect the LBA which is not used.

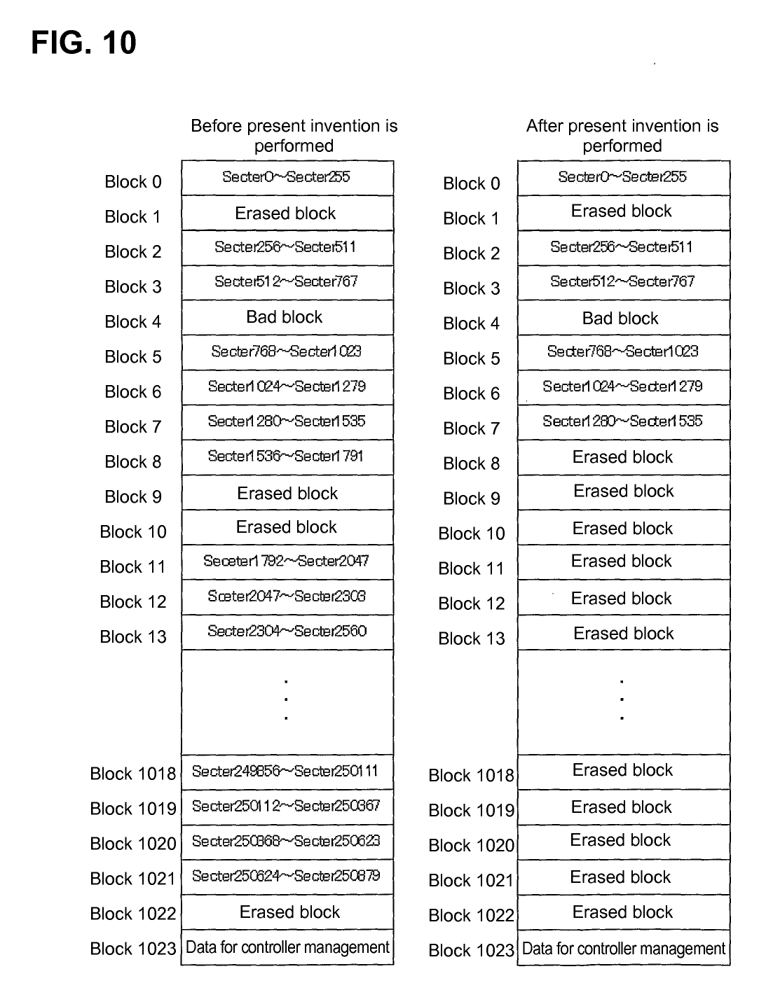

FIG. 10 is a pair of schematic views showing states of the physical block of the NAND flash memory when the unused sector is detected as described above. A left schematic view illustrates a state before the present invention is performed. As described above, in the embodiment, a cluster 0×0002, that is, a first cluster, starts from LBA 599 and a cluster size is 0×20 (32 sectors).

As shown in the FAT table in FIG. 8, in the embodiment, data are stored up to a cluster 0×001 C (28). Other clusters store no data therein. The cluster 0×001 C (28) becomes LBA-LBA 1462. When the present invention is performed, as shown in a right schematic view in the figure, the physical block composed of unused logical sectors alone is erased. Accordingly, a number of the erased blocks is increased significantly.

### Second Embodiment

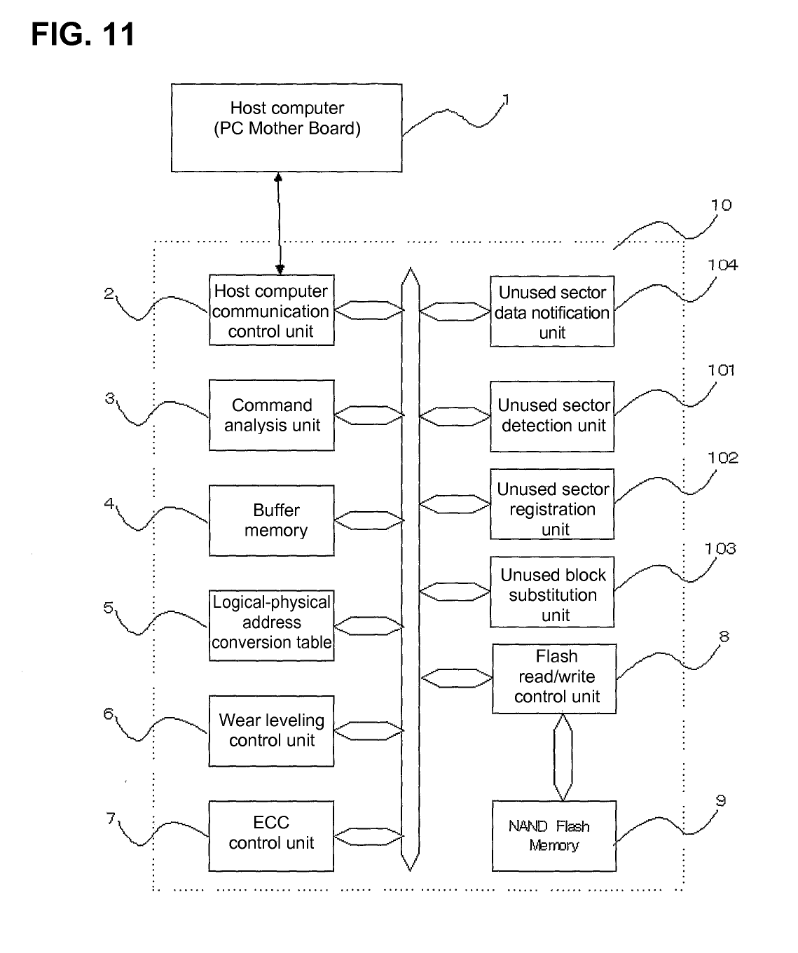

FIG. 11 is a block diagram showing another embodiment of the present invention. It is similar to the embodiment described above, except an unused sector data notification unit 104.

It is assumed that the host computer 1 sends a read command to the logical sector address which is detected by the unused sector detection unit 101 and is released from a corresponding relationship between the logical sector address and a physical sector address. When the read command is sent toward the logical sector address released from the physical sector address as described above, the unused sector data notification unit 104 sends back dummy data (for example, data composed of FFh only).

With the configuration described above, every logical sector in the entire logical sectors is allowed to send back the data to the host computer, when the read command is sent thereto, regardless of corresponding/not corresponding to the physical sector address.

### Third Embodiment

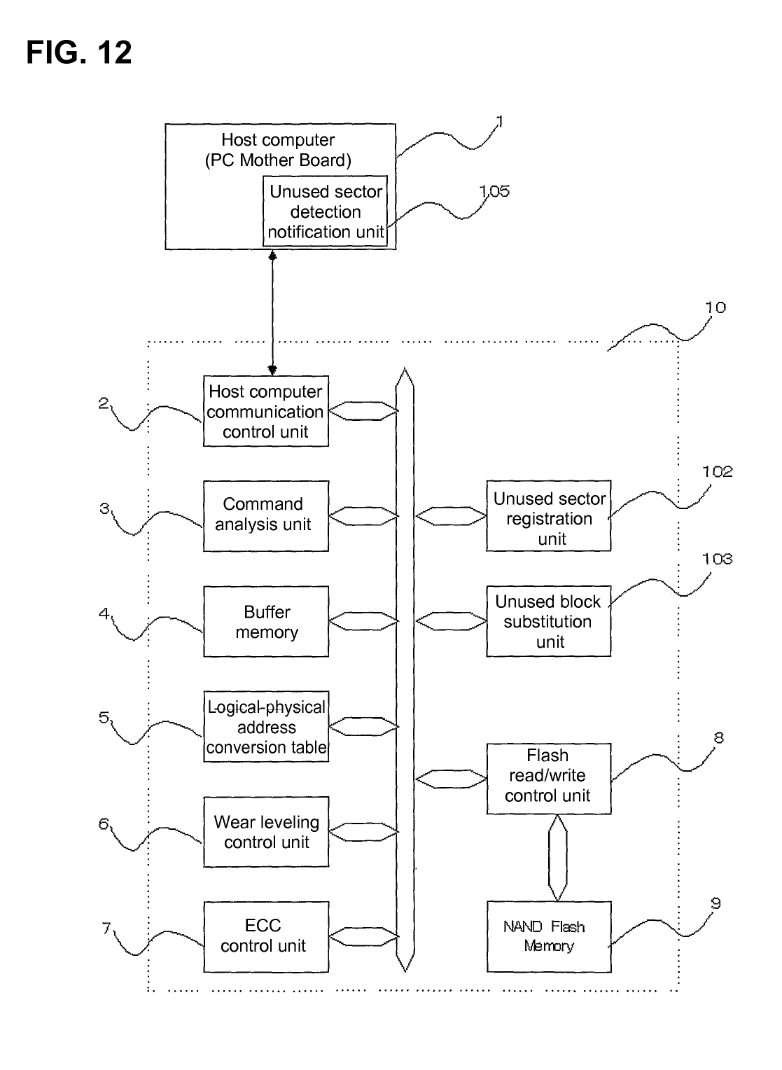

FIG. 12 is a block diagram showing another embodiment of the present invention further.

In the embodiment, the host computer 1 includes an unused sector detection notification unit 105. The storage device 10 does not include the unused sector detection unit 101. The unused sector is detected by the unused sector detection notification unit 105 by a similar process as described above. The unused sector detection notification unit 105 notifies the storage device 10 information about the unused sector which is detected.

The storage device 10 receives the information about the unused sector from the host computer 1. Further, the unused sector registration unit 102 holds the information about the unused sector, with the same process described above. In addition, the unused block substitution unit 103 erases the physical block to be usable as the substitution block for wear leveling if it is determined from the information, that the entire area of the physical block of the NAND flash memory 9 is applicable.

As described above, the host computer 1 and the storage device 10 share tasks. Accordingly, it is possible to reduce burden of the storage device 10 and to easily correspond to various file systems.

### Fourth Embodiment

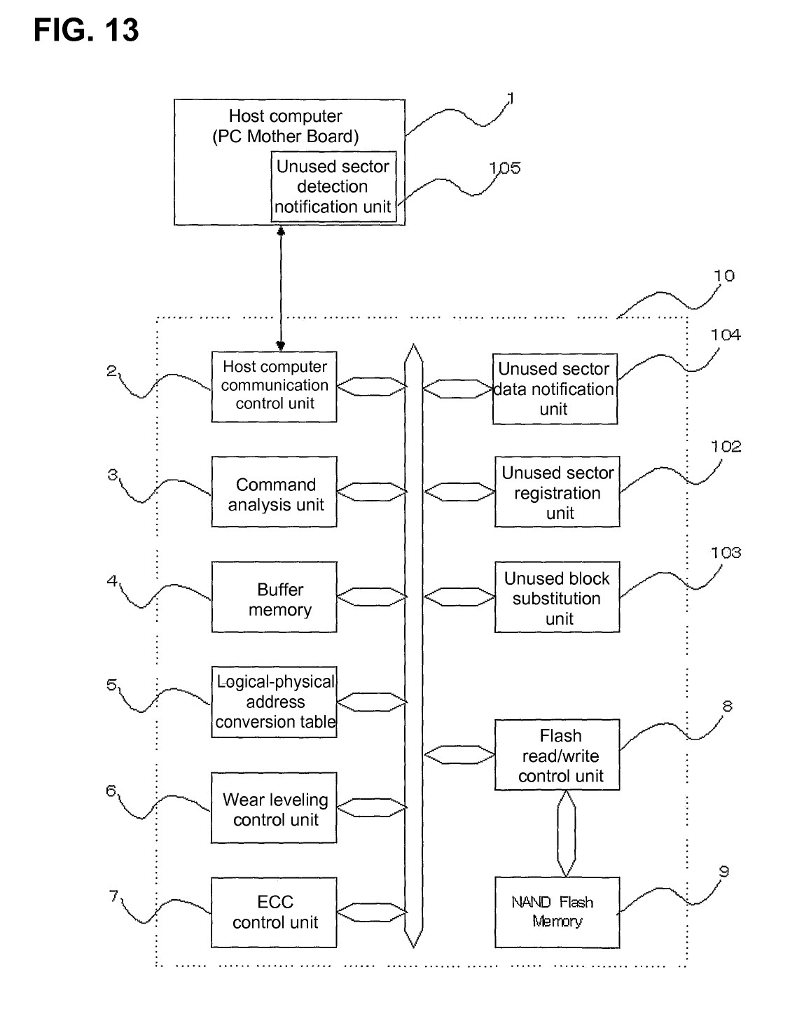

FIG. 13 is a block diagram showing another embodiment of the present invention further. It is similar to the embodiment shown in FIG. 12, except an unused sector data notification unit 104.

As explained with FIG. 11, it is assumed that the host computer 1 sends the read command to the logical sector address which is released from the corresponding relationship between the logical sector address and the physical sector address. When the read command is sent toward the logical sector address released from the relationship corresponding to the physical sector address, the unused sector data notification unit 104 sends back the dummy data (for example, data composed of FFh only). With the configuration described above, every logical sector in the entire logical sectors is allowed to send back the data to the host computer, when the read command is sent thereto, regardless of corresponding/not corresponding to the physical sector address.

### INDUSTRIAL APPLICABILITY

The present invention is applicable to a computer-related industry.

1. (canceled)

2. A storage device using a flash memory with a limited number of cycles for erasing and writing per block, wherein said flash memory includes a user area for storing data assigned from a host system and a spare block area formed of a group of blocks erased already and used for leveling a number of rewriting times of each of the blocks, comprising:
an address conversion table for managing a corresponding relationship in the user area between a logical address provided from the host system and a physical address in the flash memory;
a wear leveling control unit for directing an address management unit to exchange a physical block corresponding to the data with the physical block in the spare block area when the host system commands to rewrite the data in the user area;
an unused sector detection unit for detecting a logical sector in the user area where data are not stored according to a file system for managing stored data in the storage device, said unused sector detection unit notifying an address of the logical sector thus detected to the address management unit and directing the address management unit to cancel the corresponding relationship between the logical sector address and the physical sector address;
an unused sector registration unit for canceling the corresponding relationship between the logical sector address and the physical sector address according to the information notified from the unused sector detection unit; and
an unused block substitution unit for erasing a physical block with the canceled corresponding relationship between the logical sector address and the physical sector address among the physical blocks as an erasing unit of the flash memory, said unused block substitution unit converting the physical block to a usable block in the spare block area.

3. The storage device according to claim 2, further comprising an unused sector data notification unit for returning specific information to the host device when the host device sends a read command relative to the logical sector address with the corresponding relationship between the logical sector address and the physical sector address thus canceled.

4. An information device comprising:
a storage device using a flash memory; and
a host system of the storage device, wherein said flash memory includes a user area for storing data assigned from the host system and a spare block area formed of a group of blocks erased already and used for leveling a number of rewriting times of each of the blocks, said host system including an unused sector detection notification unit for detecting a logical sector in the user area where data are not stored according to a file system for managing stored data in the storage device, and for directing to cancel the corresponding relationship between the logical sector address thus detected and the physical sector address,
and said storage device including an unused sector registration unit for canceling the corresponding relationship between the logical sector address and the physical sector address according to information notified from the unused sector detection notification unit, and further including a block substitution unit for erasing a physical block with the corresponding relationship between the logical sector address and the physical sector address thus canceled among the physical blocks as an erasing unit of the flash memory and for converting the physical block to a usable block in the spare block area.

5. The storage device according to claim 4, wherein said storage device further includes an unused sector data notification unit for returning specific information to the host device when the host device sends a read command relative to the logical sector address with the corresponding relationship between the logical sector address and the physical sector address thus canceled.
